(19) United States
(12) Patent Application Publication
(10) Pub. No.: US 2002/0191199 A1
(43) Pub. Date: Dec. 19, 2002

(54) Printing system

(76) Inventors: Yasumasa Imada, Kyoto (JP); Hiroyuki Yamamoto, Kyoto (JP); Yukinori Ninomiya, Kyoto (JP); Eiichi Ine, Kyoto (JP)

Correspondence Address: MCDERMOTT WILL & EMERY, 600 13TH STREET, N.W., WASHINGTON, DC, 20005-3096, US

(21) Appl. No.: 10/143,837

(22) Filed: May 14, 2002

(30) Foreign Application Priority Data
May 15, 2001 (JP) P2001-144777
May 8, 2002 (JP) P2002-133030

(51) Int. Cl. B41B 1/00; G06F 15/00

(52) U.S. Cl. 358/1.1

(57) ABSTRACT

A printing system making easy to obtain a printed matter that the customer desires is provided to eliminate the conventional technique's drawback that the customer might fail to obtain the desired printed matter because it is made by using only plural layout patterns and photographic images stored in the printing dealer's server. Specifically, a client (computer) has a rough layout data creation part with which when a layout list information is inputted to the client, an expression information stored in the layout list information is allocated in simplified form thereby to create a rough layout data. A server receives the rough layout data outputted from the client and creates, based on the rough layout data, a print layout data in which a part data read from a part data storing part are allocated, and performs printing. This requires no detail print setting on the customer side, thus making easy to obtain the printed matter having the desired layout.

### BACKGROUND OF THE INVENTION

1. Field of the Invention

The present invention relates to a printing system using network technology and, in particular, to a printing system for ease in printing.

2. Description of the Background Art

Service to customers that was unavailable heretofore has been provided recently by using internet.

Not excepting the printing industry, when placing an order with a printing dealer for obtaining a desired printed matter, it was necessary to go to the printing dealer for determining layout and arrangement of the desired printed matter one by one. In contrast, the desired printed matter is presently obtainable more efficiently than has been conventional, by such a technique that without need for going to a printing dealer, the desired printed matter can be obtained by using network such as internet. This technique is for example disclosed in Japanese Patent Unexamined Publication No. 11-91189 (1999).

However, the conventional technique suffers from the problem that the customer might fail to obtain the desired printed matter because it is made by using only plural layout patterns and photographic images stored in the printing dealer's server.

For instance, to emphasize a specific article in such a printed matter as leaflet, it is often desired to express only the entry of the specified article in enlarged dimension. However, this desire might not be complied with the plural layout patterns stored in the printing dealer's server. In addition, even if a specific photographic image is demanded, that might not be stored in the printing dealer's server, thus failing to obtain the desired printed matter.

Of course, the printed matter can be obtained in the following manner that the customer creates a printing data having a layout to emphasize a specific article by using a specific photographic image and sends the printing data to a printing dealer. With this method, the customer has too many things on his/her hands, and the customer might not have any software for obtaining the printing data.

### SUMMARY OF THE INVENTION

The present invention has for its object a printing system using network technology.

According to this invention, a printing system includes: (i) a client computer which includes: a) a layout list creation element for creating at least one layout list information, the layout list information containing at least one expression information that is information expressed on a printed matter; b) a rough layout data creation element for creating a rough layout data based on the layout list information; and c) a sending element for sending the rough layout data to a network; (ii) a first server computer which includes: d) a receiving element for receiving the rough layout data from the network; e) a part data storage element for storing a part data used in expressing a printed matter; f) a print layout data creation element for creating a print layout data based on the rough layout data; and g) a print control element for directing a printer to print the print layout data, said first server computer connected to the printer that receives a print layout data from the exterior of the printer and performs printing.

According to one preferred embodiment of the invention, the rough layout data in which the contents that the user desires to express in a printed matter are allocated in simple form is created in the client computer.

Preferably, the rough layout data is received by the server computer via the network, and the print layout data of the printed matter that the user desires is created on the server computer.

Preferably, according the user's instruction through the client computer, the printer under control of the server computer performs printing based on the print layout data.

With this configuration, the user can obtain a printed matter having the desired layout, without operating the server computer that controls the printer.

It is therefore the object of the present invention that the user can easily obtain the desired printed matter without making any detail setting.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the configuration of a printing system according to a first preferred embodiment of the invention;

FIG. 2 is a diagram showing the configuration of client in FIG. 1;

FIG. 3 is a diagram showing the configuration of server in FIG. 1;

FIG. 4 is a flowchart showing the operation of the printing system in FIG. 1;

FIG. 5 is a flowchart showing the operation of creating a rough layout data in the client in FIG. 2;

FIG. 6 is a diagram showing the configuration of a layout list;

FIGS. 7A and 7B are diagrams showing layout setting data creation and its configuration;

FIGS. 8A and 8B are diagrams showing examples of creating divided section areas;

FIGS. 9A and 9B are diagrams showing examples of creating split allocation areas;

FIGS. 10A and 10B are diagrams showing creation of expression-information-style setting information and its configuration;

FIGS. 11A and 11B are diagrams showing the configuration of rough layout data;

FIG. 12 is a flowchart showing edit processing to a rough layout data in the client of FIG. 1;

FIGS. 13A and 13B are diagrams showing the configuration of an after-edit rough layout data;

FIG. 14 is a diagram showing the configuration of a text script created by converting rough layout data;

FIG. 15 is a diagram showing the configuration of a print layout data;

FIG. 16 is a diagram showing the configuration of a printing system using a CTP;

FIG. 17 is a diagram showing the configuration of a printing system according to a second preferred embodiment of the invention;

FIG. 18 is a diagram showing the configuration of a layout server in FIG. 17;

FIG. 19 is a flowchart showing the operation of the printing system in FIG. 17; and

FIG. 20 is a diagram showing the configuration of other printing system using a CTP.

### DESCRIPTION OF THE PREFERRED EMBODIMENTS

First Preferred Embodiment

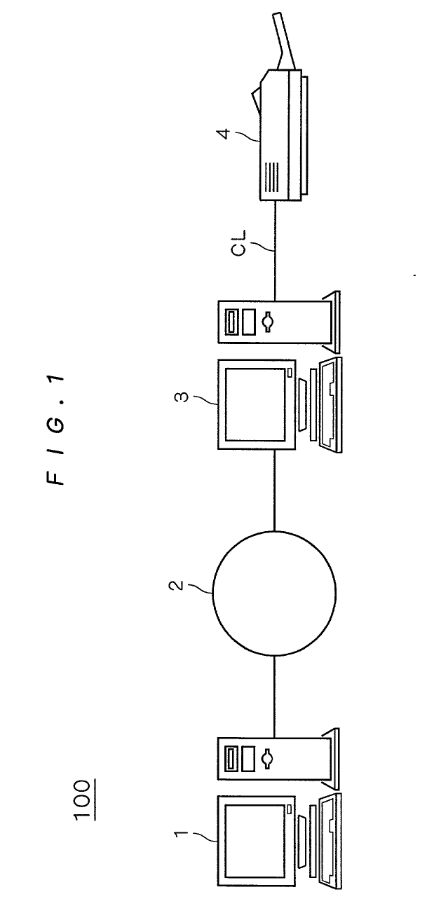

FIG. 1 is a diagram showing the configuration of printing system 100 according to a first preferred embodiment of the invention. The printing system 100 comprises client 1, network 2, server 3, and printer 4.

The client 1 is a computer in general use that is placed under control of the user requiring a printed matter. The user operating the client 1 creates a layout list information containing such expression information AJ and image-data storage location information that the user desires to express in a printed matter to be made and arranges, in simplified form, the expression information AJ and the image-data storage location information contained in the layout list information by using a rough layout application provided in the client 1. In the rough layout application, a rough layout data is created from the simplified layout result and sent to the server 3 via the network 2.

The network 2 is a network on which the client 1 is connected to the server 3, and is implemented as public network or internet.

The server 3 is placed under control of a printing dealer that makes a printed matter. By referring to the rough layout data sent from the client 1, the server 3 creates a print layout data in which part data BD necessary for printing are allocated, and performs printing in the printer 4 connected to the server 3.

Although in the above instance only one client 1 is connected to the network 2, a plurality of clients 1 may be connected to the network 2.

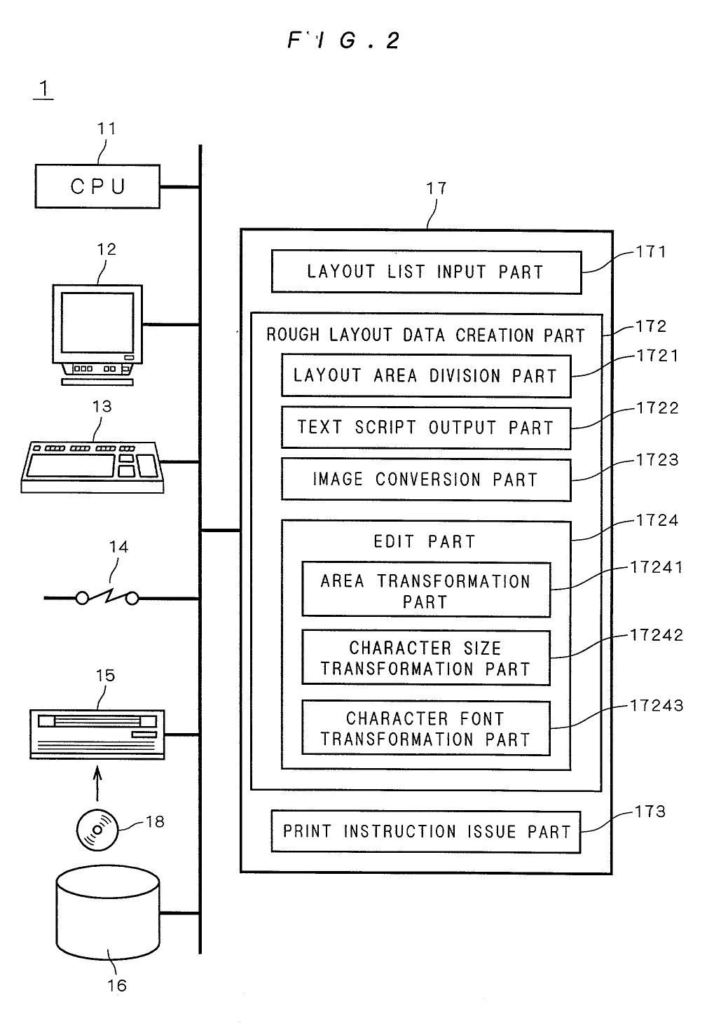

FIG. 2 is a diagram showing the configuration of client 1. The client 1 is a personal computer in general use and comprises CPU 11, display part 12, input part 13, network interface 14, media drive 15, storage part 16, and memory 17. The CPU 11 controls the entire client 1 and implements the functions of client 1 by particularly executing in the memory 17 a program that is stored in the media disk 18 inserted in the media drive 15. The display part 12 displays information that the operator desires. The input part 13 comprises a mouse and keyboard and is used when the operator inputs instructions to the client 1. The network interface 14 connects between the client 1 and network 2. Through the network interface 14, the client 1 sends a rough layout data KLD to the server 3 connected to the network 2, and also receives image data IM stored in the server 3, as well as a proof image KD sent from the server 3. The program that implements the functions of client 1 can be downloaded from the server 3. The media drive 15 reads the program stored in the media disk 18. The program read in the media drive 15 implements the function of client 1. The media drive 15 also reads a layout list LL stored in the media disk 18. The storage part 16 stores the program read by the media drive 15 and also stores the layout list LL, rough layout data KLD, or image data IM.

The memory 17 is a work area where the CPU 11 executes the program stored by the storage part 16. The CPU 11 executes the program to implement, in the memory 17, the functions of layout list creation part 171, rough layout data creation part 172, and print instruction issue part 173.

The layout list creation part 171 creates a layout list LL that contains expression information AJ and image-data storage location information necessary for obtaining a desired printed matter. The layout list LL is a file that contains expression information AJ and image-data storage location information to be expressed in the printed matter. The layout list LL can contain expression information AJ and image-data storage location information for layout in units of records, by inputting text information to entries that are delimited by a comma, and separating records by a return code, as in a file of CSV format. The user can directly input the layout list LL to the client 1 by using the layout list creation part 171. It is also possible that a database information in general use is converted to a layout list LL and inputted to the client 1.

The rough layout data creation part 172 is used for performing rough layout in the client 1. In the rough layout data creation part 172, there is set a layout area corresponding to the sheet size of the printed matter, and a page style such as printing sheet direction, as well as the style of allocating the expression information AJ stored in the layout list LL to a layout area. Further in the rough layout data creation part 172, the state of layout of image data IM is displayed based on image-data storage location information stored in the contents of the layout list LL. Rough layout data KLD created in the rough layout data creation part 172 is sent from the client 1 to the server 3 and used for printing processing.

For the purpose of these, the rough layout data creation part 172 further comprises layout area division part 1721, text script output part 1722, image conversion part 1723, and edit part 1724.

The layout area division part 1721 divides a layout area LE of the printed matter (i.e., print area) based on the number of records in the layout list LL. In case of printing leaflets or catalogues, it is necessary to divide page space per article. When the rough layout data creation part 172 performs rough layout for this printed matter, based on the layout list LL, the layout area division part 1721 divides a layout area LE according to the number of records in the layout list LL, thereby forming split allocation areas BHL to which the expression information AJ and the image data IM described by image-data storage location information stored in the layout list LL are allocated.

When plural layout lists LL are inputted, the layout area division part 1721 forms divided section areas BKL that are obtained by dividing the layout area LE per layout list LL, and forming split allocation areas BHL corresponding to the layout list LL per divided section area BKL. That is, in order to obtain such a printed matter that expression information AJ of different genres are put on a single page, a plurality of layout lists LL are inputted in some cases. In this instance, the layout area division part 1721 forms split allocation areas BHL based on the number of records of each layout list LL, because divided section areas BKL are firstly formed for the respective layout lists LL and then the expression information AJ and the image data IM described by image-data storage location information stored in the layout lists LL are allocated.

The text script output part 1722 outputs a rough layout data KLD created by the rough layout data creation part 172, as a text script to which a format information such as a tag is appended. When the rough layout data KLD is outputted in a format at the time of input, its data size is too large so that an additional time might be necessary to send it to the server 3 via the network 2. Therefore, the text script output part 1722 outputs the rough layout data KLD as a text script to which a format information such as a tag is appended. Thereby, the load on sending the data to the server 3 via the network 2 can be decreased to save transfer time. For example, XML (extensible markup language) and HTML (hyper text markup language) can be used as a text script format of rough layout data KLD that the text script output part 1722 outputs.

The text script output part 1722 outputs the rough layout data KLD as a text script TS, and sends it to the server 3 via the network interface 14.

In the case that when creating a rough layout data KLD, it is necessary to read image data IM described by image-data storage location information stored in a layout list LL, the image conversion part 1723 converts the image data IM into a low-resolution image data LIM by skipping the pixels of the image data IM. Even in rough layout operation in the client 1, it is often desired to visually confirm the state that images are allocated to the layout area LE. In this case, however, there is little or no necessity of using image data having a high resolution (i.e., having a large data size) in the rough layout operation in the client 1. Therefore, when the rough layout data creation part 172 reads image data IM from its storage location described by image-data storage location information stored in the layout lists LL, the image conversion part 1723 converts the image data IM to a low-resolution image data LIM that is obtained by skipping pixels of the image data IM. With this configuration, visual confirmation of image layout on the layout areas LE in the client 1 is attainable while decreasing the load on the client 1.

The edit part 1724 edits a rough layout data KLD created by the rough layout data creation part 172. This rough layout data KLD is obtained by allocating expression information AJ and image data IM described by image-data storage location information, in a style common to every split allocation area BHL, to the split allocation areas BHL that are obtained by dividing a layout area LE based on the number of records in a layout list LL. Therefore, it is impossible to comply with demands such as enlargement to a split allocation area BHL where a specific expression information AJ or image data IM described by image-data storage location information is allocated, and the character size or font transformation in a specific expression information AJ. To solve this problem, the edit part 1724 has area transformation part 17241, character size transformation part 17242, and character font transformation part 17243.

The area transformation part 17241 transforms the area size of split allocation area BHL created by the layout area division part 1721. When the user operates the input part 13 to select the desired split allocation area BHL and input its size transformation, the area transformation part 17241 transforms the size of the selected split allocation area BHL according to the user's input.

The character size transformation part 17242 transforms the character size of expression information AJ. When the user operates the input part 13 to select the desired expression information AJ and input its character size transformation, the character size transformation part 17242 transforms the character size of the selected expression information AJ according to the user's input.

The character font transformation part 17243 transforms the character font of expression information AJ. When the user operates the input part 13 to select a desired expression information AJ and inputs its character font transformation, the character font transformation part 17243 transforms the character font of the selected expression information AJ according to the user's input.

As described above, the user of client 1 activates the function of edit part 1724 to customize a rough layout data KLD by performing edit to the rough layout data KLD, such as enlarged-scale display of a split allocation area BHL to which a specific expression information AJ is allocated, transformation in character size or font of expression information AJ.

The print instruction issue part 173 issues a print instruction to the server 3. That is, after print layout data PLD is created in the server 3, the user of client 1 operates the input part 13 and directs the print instruction issue part 173 to issue a print instruction as a script that contains the user name, the number of copies of the printed matter, and printed matter destination, etc. The issued print instruction is sent to the server 3 via the network 2, thereby making a print processing part 374 execute printing.

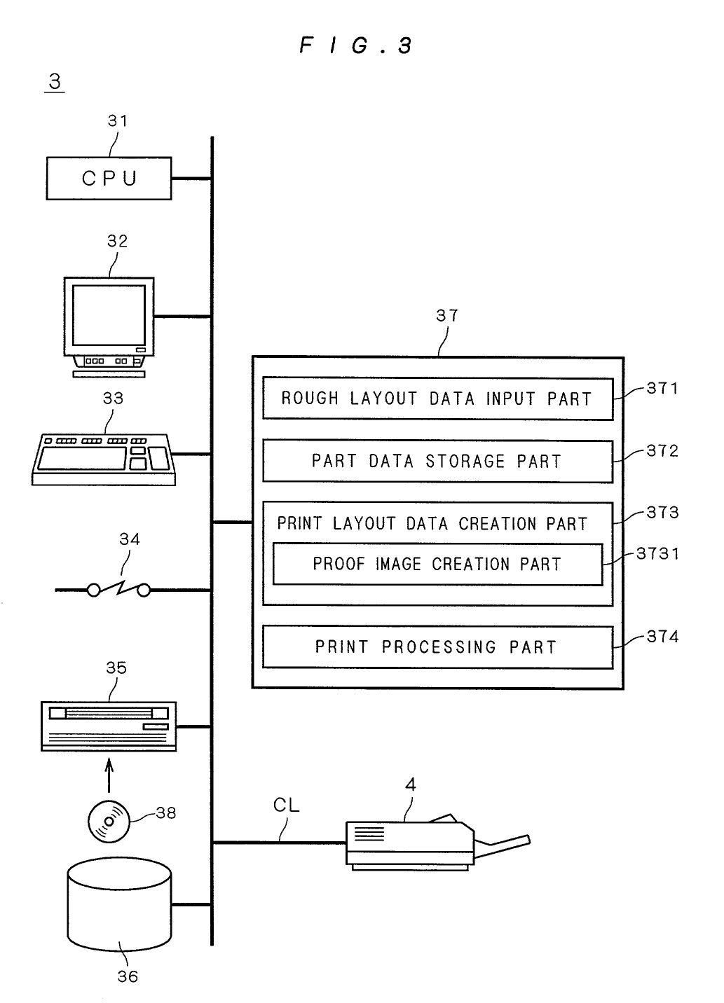

FIG. 3 is a diagram showing the configuration of server 3. The server 3 is also a personal computer in general use and comprises CPU 31, display part 32, input part 33, network interface 34, media drive 35, storage part 36, and memory 37. The CPU 31 controls the entire server 3 and implements the functions of server 3 by particularly executing in the memory 37 a program that is stored in the media disk 38 inserted in the media drive 35. The display part 32 displays the information that the operator desires. The input part 33 comprises a mouse and keyboard and is used when the operator inputs instructions to the server 3. The network interface 34 connects between the server 3 and network 2. Through the network interface 34, the server 3 receives a rough layout data KLD and image data IM from the client 1 connected to the network 2. The server 3 also sends the client 1 an image data IM and proof image KD that are stored in the server 3. The program that implements the functions of server 3 can be downloaded from other server (not shown). The media drive 35 is used for reading the program stored in the media disk 38. The program read by the media drive 35 implements the function of the server 3. The media drive 35 can also be used to read a rough layout data KLD stored in the media disk 38. The storage part 36 stores the program read by the media drive 35 and also stores the rough layout data KLD, print layout data PLD, proof image KD, or image data IM. Communication line CL is connected to printer 4 and used for sending rasterized print data RPD that is obtained by rasterizing a print layout data PLD. The printer 4 performs printing based on the rasterized print data RPD, thereby obtaining the printed matter having the contents that the user of client 1 desires to print.

The memory 37 is a work area where the CPU 31 executes the program stored by the storage part 36. When the CPU 31 executes the program, the functions of rough layout data creation part 371, part data storage part 372, print layout data creation part 373, and print processing part 374, are implemented in the memory 37.

The rough layout data creation part 371 receives a rough layout data KLD sent from the client 1 via the network 2, and performs conversion necessary for creating a print layout data in the server 3. The rough layout data creation part 371 also receives through the network interface 34 a rough layout data KLD that is sent from the client 1 via the network 2. When the rough layout data KLD is a text script, it is converted in a format acceptable to the print layout data creation operation in the print layout data creation part 373.

The part data storage part 372 stores a part data BD necessary for print layout data creation in the print layout data creation part 373. Typical representatives of the part data BD necessary for print layout data creation are data of font, line drawing, and image. The part data storage part 372 stores these part data BD and provides them when the layout data creation part 373 creates a print layout data PLD from a rough layout data KLD.

The part data storage part 372 may-be disposed in the storage part 36.

The print layout data creation part 373 creates a print layout data PLD acceptable to the printer 4, based on the rough layout data KLD created in the client 1. Specifically, the print layout data creation part 373 fetches the necessary part data BD from the part data storage part 372 and creates a print layout data PLD that has the same format as the rough layout data and also has improved expression accuracy.

The print layout data creation part 373 further comprises a proof image creation part 3731. The proof image creation part 3731 creates a proof image KD, based on which the user of client 1 judges whether the desired printed matter is obtainable with a print layout data PLD created by the print layout data creation part 373. Specifically, the proof image creation part 3731 creates the proof image KD that corresponds to the expression contents of print layout data PLD, and sends it to the client 1 via the network 2. The user of client 1 can judge whether the creations of the rough layout data KLD in the client 1 and the print layout data PLD in the server 3 are satisfactory or not by checking the proof image KD.

It is desirable that the proof image KD created in the proof image creation part 3731 expresses the contents of print layout data PLD at high accuracy. For example, PDF (portable document format) is preferably used.

The print processing part 374 converts the print layout data PLD created by the print layout data creation part 373, to data in a format acceptable to the printer 4. For instance, if a certain print layout data PLD created by the print layout data creation part 373 is in page description language format such as PostScript (trademark of Adobe Systems Incorporated, USA), it is impossible for the printer 4 to print this print layout data PLD as it is. Therefore, the print processing part 374 subjects the print layout data PLD to rasterization by which it is converted to a rasterized print data RPD in a format acceptable to the printer 4. This print data RPD obtained by the conversion is sent to the printer 4 via the communication line CL, and the printer 4 performs printing of the printed matter that the user of client 1 desires.

The print processing part 374 is controlled so as not to execute printing until the client 1 issues a print instruction. Specifically, the print processing part 374 performs no print processing such as rasterization to print layout data PLD until the user of client 1 judges that the desired printed matter is obtainable by checking the proof image KD created in the proof image creation part 3731.

The print processing part 374 may further have the same function as the print instruction issue part 173 in the client 1. In this instance, the same effect as described above can be obtained when the user of client 1 accesses to the print processing part 374 via the network 2 and issues a print instruction.

The above-mentioned control prevents unnecessary operation in the print processing part 374, thereby avoiding a waste of the resources in the server 3.

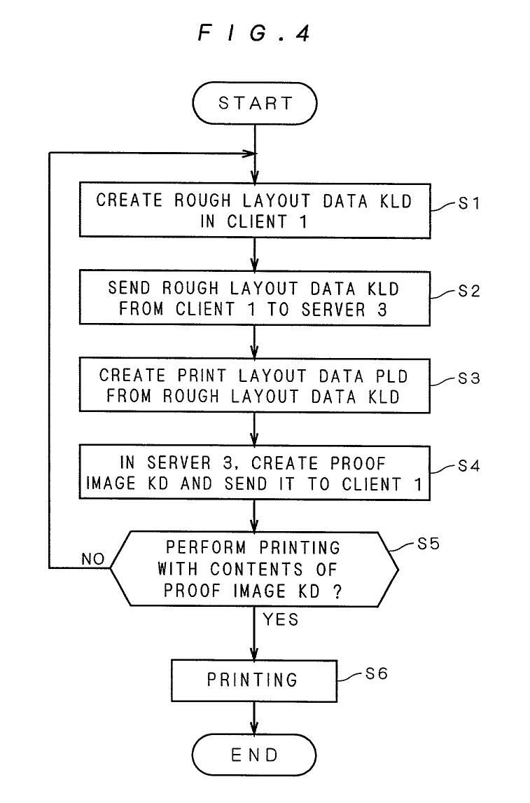

FIG. 4 is a flowchart showing the operation of the printing system 100.

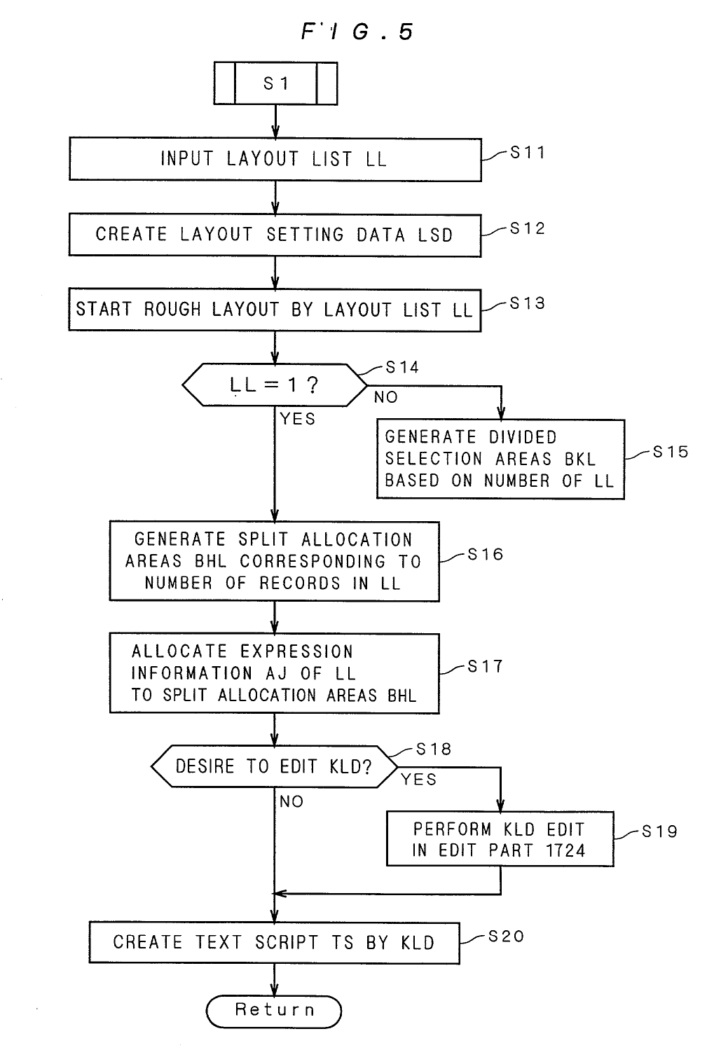

First, in step S1, the client 1 creates a rough layout data KLD by performing operations shown in FIG. 5.

In step S11 of FIG. 5, for obtaining the desired printed matter, the user of client 1 inputs a layout list LL to the client 1. The layout list LL can be inputted to the client 1 in the following manners. Firstly, the user operates the layout list creation part 171 for direct input of the layout list LL. Secondly, a media disk 18 storing the layout list LL is loaded in a media drive 15, and the layout list LL is read for edit processing from the media disk 18. Thirdly, database information stored in a database (not shown) provided in the client 1 is converted to the layout list LL in the layout list creation part 171. Fourthly, database information stored in a database (not shown) in the server 3 or other server (not shown) is downloaded, and converted to the layout list LL. The inputted layout list LL is then stored in the storage part 16.

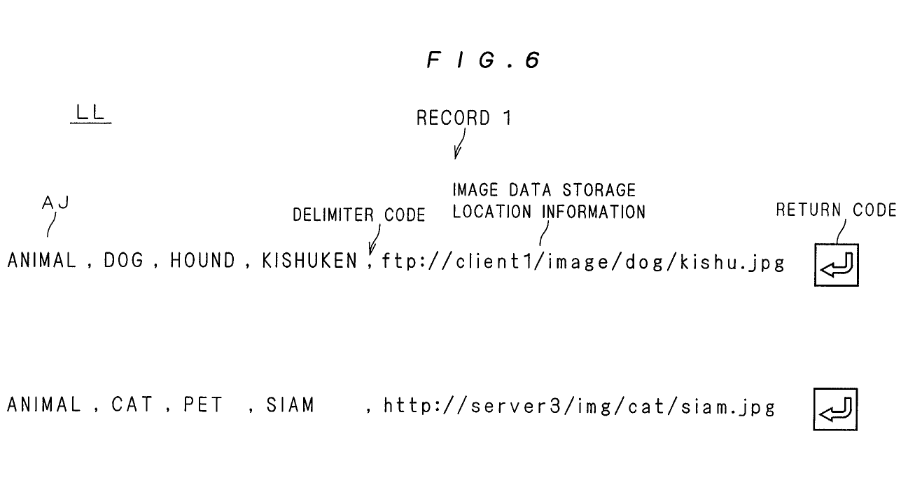

FIG. 6 is a diagram showing an example of the configuration of the layout list LL. There is shown a text screen of the layout list LL that is inputted by the layout list creation part 171. As shown in FIG. 6, one entry and other entry on the layout list LL are delimited by a predetermined delimiter code, “,” (comma). Entries that are divided by the delimiter code contain expression information AJ and image-data storage location information. Records are separated by a return code appended to each line.

On the first line of the layout list LL in FIG. 6, first, second, third, and fourth entries contain expression information as a first record, such as “animal,” “dog,” “hound,” and “kishuken”, respectively. The fifth entry contains an image-data storage location informations instead of expression information AJ. When the rough layout data creation part 172 reads the image-data storage location information from the layout list LL, the image data IM stored at the location described in this location information is read for performing rough layout. In FIG. 6, the image data storage location information is a URL, “ftp://client1/image/dog/kishu.jpg”. This means that image data, “kishu.jpg,” is stored at “ftp” site of the storage part 16 in the client 1. Therefore, at the time of rough layout data creation to be described later, the rough layout data creation part 172 reads image data IM by referring to the URL that is the image data storage location information. Then the first line is separated by a return code after the fifth entry. That is, the expression information AJ stored in the first record are “animal,” “dog,” “hound,” and “kishuken”, and the image data storage location information is “ftp://client1/image/dog/kishu.jpg.”

In a second record, entries contain expression information AJ and image data storage location information, as in the first record. The image data storage location information in the second record is other URL, “http://server3/img/cat/siam.jpg,” which is different from that in the first record. This means that the image data IM corresponding to the second record is stored at “http” site in the server 3. Therefore, at the time of rough layout data creation to be described later, the rough layout data creation part 172 reads image data IM by referring to the URL that is the image data storage location information.

As described above, the layout list LL can contain different image data storage location information for different records. It is therefore possible to use any desired image data without limiting to one that the server 3 stores as image data used for printed matter.

As image data storage location information, directory name that contains image data may be used instead of URL.

Returning to FIG. 5, in step S12, the user of client 1 sets the page style of the desired printed matter by activating the function of rough layout data creation part 172. Specifically, by operating the input part 13, the user inputs information necessary for setting a page style such as printing sheet size and sheet direction of the desired printed matter, to the rough layout data creation part 172. As the result, a layout setting data LSD is created in the rough layout data creation part 172.

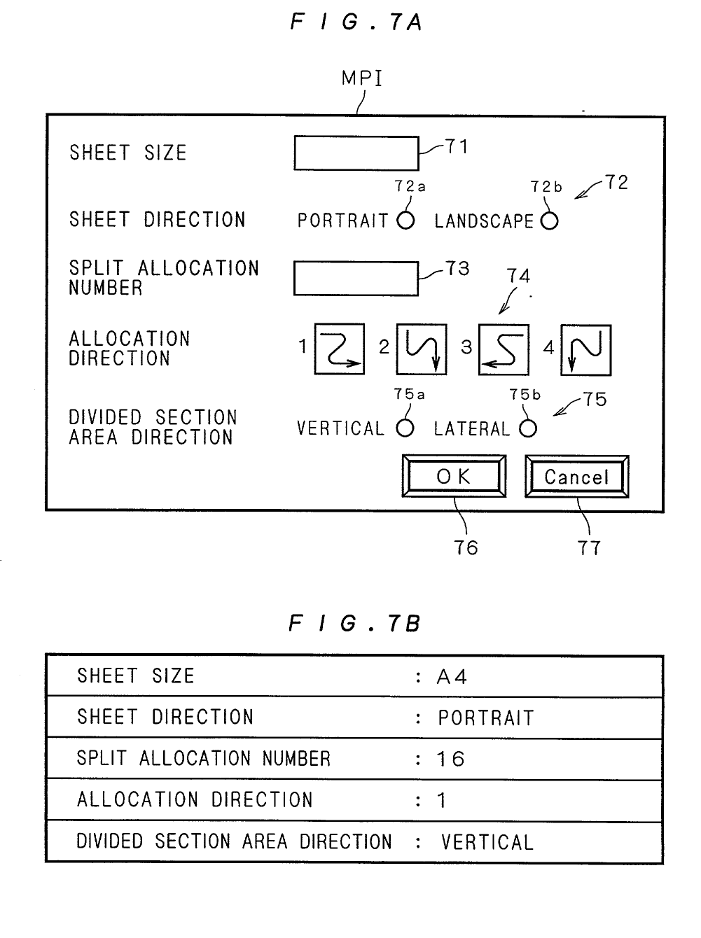

FIGS. 7A and 7B are diagrams showing page style setting in the rough layout data creation part 172. FIG. 7A shows a page style input menu MPI that is displayed on the display part 12 by the rough layout data creation part 172. The user inputs to the page style input menu MPI by operating the input part 13. Thereby, the rough layout data creation part 172 creates a layout setting data LSD.

In order that the rough layout data creation part 172 creates a layout setting data LSD, the page style input menu MPI has a sheet size input field 71, sheet direction input field 72, split allocation number input field 73, allocation direction input field 74, divided-section-area direction input field 75, OK button 76, and cancel button 77.

The sheet size input field 71 is used for inputting the sheet size of the desired printed matter. Sheet size per page in a layout setting data LSD can be set when the user inputs the desired sheet size to the sheet size input field 71 by operating the input part 13.

The sheet direction input field 72 is used for inputting the sheet direction of the desired printed matter. The sheet direction input filed 72 has a portrait orientation input button 72a and landscape orientation input button 72b for selecting portrait or landscape orientation as a sheet direction. The sheet direction per page in a layout setting data LSD can be set when the user operates the input part 13 and inputs the desired sheet direction by clicking the button 72a or 72b. Click of the buttons 72a and 72b is performed exclusively. That is, both buttons cannot be clicked at a time.

The split allocation number input field 73 is used for inputting an upper limit of split allocation areas BHL in a desired printed matter. For a large number of records in a layout list LL, if split allocation areas BHL corresponding to the number of records are generated in a layout area LE of one page, the area size of each split allocation area BHL is extremely small and it might be unserviceable as a printed matter. Therefore, by inputting the upper limit of the numbers of split allocation areas BHL in the layout area LE of one page, to the split allocation number input field 73, the desired printed matter can be obtained without causing any problem involved in the size of split allocation area BHL. Specifically, the upper limit of split allocation number per page in the layout setting data LSD can be set when the user operates the input part 13 to input the desired upper limit of split allocation number to the split allocation number input field 73. When the number of records in a layout list LL is more than the number inputted to the split allocation number input field 73, the simply layout data creation part 172 adds a proper number of pages.

The allocation direction input field 74 is used for inputting the allocation direction of expression information AJ in a desired printed matter. The allocation direction of expression information AJ in a printed matter can be selected from the followings: (i) “from the uppermost on the left side of the sheet to downward toward the right, preferentially in a direction laterally to the sheet,” (ii) “from the uppermost on the left side of the sheet to downward toward the right, preferentially in a direction longitudinally to the sheet,” (iii) “from the uppermost on the right side of the sheet to downward toward the left, preferentially in a direction laterally to the sheet,” and (iv) “from the uppermost on the right side of the sheet to downward toward the left, preferentially in a direction longitudinally to the sheet.” The allocation direction input field 74 has allocation direction buttons for inputting these allocation directions. The allocation direction per page in a layout setting data LSD can be set when the user operates the input part 13 to set the desired allocation direction by clicking one of the allocation direction buttons in the allocation direction input field 74.

The divided-section-area direction input field 75 is used for inputting the allocation direction of divided section areas BKL in a desired printed matter. In order to generate divided section areas BKL based on plural layout lists LL in a layout area LE of one page, it is necessary to determine how the divided section areas BKL are allocated (i.e., allocation direction). To provide for this, the divided-section-area direction input field 75 has a vertical allocation input button 75a and lateral allocation input button 75b. When the user clicks the vertical layout input button 75a, the layout area division part 1721 vertically allocates the divided section areas BKL to the layout area LE of one page. When the user clicks the lateral allocation input button 75b, the layout area division part 1721 laterally allocates the divided section areas BKL to the layout area LE of one page. Specifically, the allocation direction of divided section areas BKL per page in a layout setting data LSD can be set when the user operates the input part 13 to input the desired allocation direction of the divided section areas BKL to the divided-section-area direction input field 75. Click of the buttons 75a and 75b is performed exclusively. That is, both buttons cannot be clicked at a time.

When all the contents inputted to the page style input menu MPI are satisfactory, the user clicks the OK button 76. The rough layout data creation part 172 creates a layout setting data LSD based on the setting so inputted, and terminates the page style input menu MPI. If the user is unsatisfied with the input contents or desires to cancel input to the page style input menu MPI in the midway, the user clicks the cancel button 77. As the result, the rough layout data creation part 172 terminates the page style input menu MPI.

FIG. 7B is a diagram showing the configuration of a layout setting data LSD created by inputs to the page style input menu MPI. In FIG. 7B, the layout setting data LSD contains, as the setting per page, the following information: “A4” in the sheet size; “portrait orientation” in the sheet direction; “16” in the spit allocation number, “from the uppermost on the left side of the sheet to downward toward the right, preferentially in a direction laterally to the sheet; and “vertical” in the divided section area direction.

Returning to FIG. 5, in step S13, the user specifies a layout list LL stored in the storage part 16, and directs the rough layout data creation part 172 to start rough layout based on the layout list LL. Thereby, the rough layout data creation part 172 starts rough layout.

In step S14, the rough layout data creation part 172 judges whether or not the user specifies plural layout lists LL. If plural layout lists LL are specified, it goes to step S15. If not, it goes to step S16.

In step S15, the layout area division part 1721 divides a layout area LE into plural divided section areas BKL according to the number of layout lists LL, by referring to the “divided section area direction” that has been stored in the layout setting data LSD created in step S12. The divided section areas BKL are generated in the following manner. That is, a reference side to be divided is found from the “divided section area direction” stored in the layout setting data LSD, and the size of the reference side that can be found from “sheet size” is equally divided by the number of layout lists “n”.

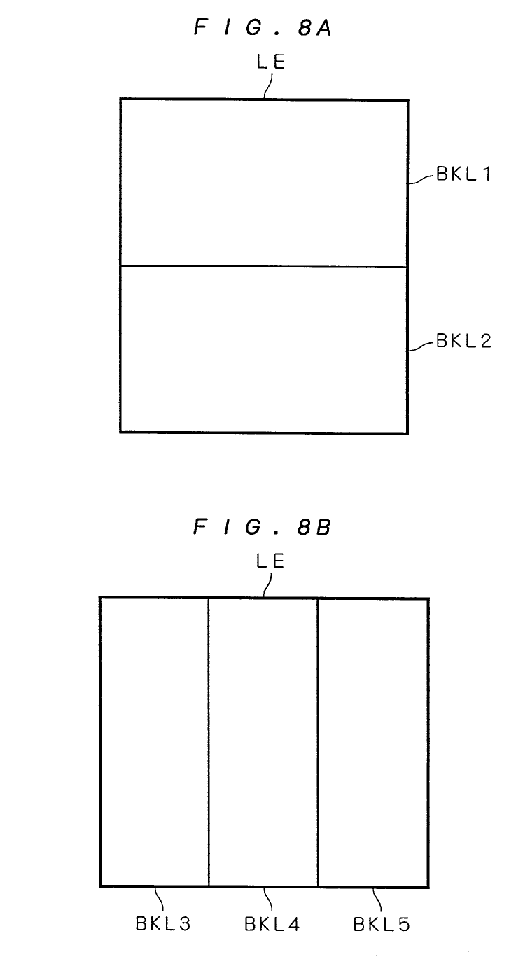

For instance, when the number of layout lists LL is “2” and the “divided section area direction” stored in the layout setting data LSD is “vertical,” the layout area division part 1721 divides a layout area LE into equal parts by taking its longitudinal side as a reference side, thereby obtaining divided section areas BKL1 and BKL2, as shown in FIG. 8A. When the number of layout lists LL is “3” and the “divided section area direction” stored in the layout setting data LSD is “lateral,” the layout area division part 1721 divides a layout area LE into three equal parts by taking its lateral side as a reference side, thereby obtaining divided section areas BKL3, BKL4, and BKL5, as shown in FIG. 8B.

After obtaining divided section areas BKL in the layout area LE, it goes to step S16.

In step S16, the layout area division part 1721 divides a layout area LE into split allocation areas BHL according the number of records in a layout list LL. The split allocation areas BHL are generated by equally dividing the area of the layout area LE or the area of divided section areas BKL, by the number of records in the layout list LL “m”. When the number of records “m”, is more than the number stored in the “split allocation number” of the layout setting data LSD, the layout area division part 1721 divides the layout area LE by the number stored in the “split allocation number,” thereby obtaining split allocation areas BHL.

When obtaining these split allocation areas BHL, the layout area division part 1721 refers to the setting of “allocation direction” in the layout setting data LSD. For obtaining three or more split allocation areas BHL, it is necessary to perform not only division in parallel only to longitudinal or lateral side of the sheet, but also at least one division in a direction vertical thereto.

The layout area division part 1721 performs numbering of the obtained split allocation areas BHL, which will be used in the step described later. Numbering to each split allocation area BHL is determined by the “allocation direction” stored in the layout setting data LSD. When the “allocation direction” is “from the uppermost on the left side of the sheet to downward toward the right, preferentially in a direction longitudinally to the sheet,” the layout area division part 1721 numbers “1” to a split allocation area BHL locating at the uppermost left in a layout area LE or divided section area BKL, thereby obtaining split allocation area BHL1. As long as there is one adjacent to the split allocation area BHL1 on the right-hand side thereof, numbering, e.g., “2”, “3”, to split allocation areas BHL is continued. If no split allocation area BHL is present adjacent to the right side, it is retrieved whether non-numbered split allocation area BHL remains in the upper part on the left side of the layout area LE or divided section area BKL, and numbering is resumed, if any.

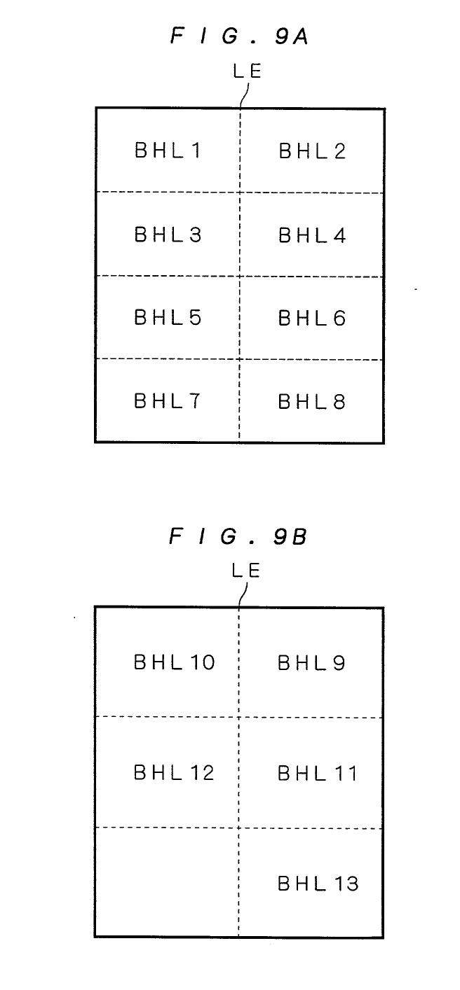

For instance, when the number of records in a layout list LL is “8” and the allocation direction is “from the uppermost on the left side of the sheet to downward toward the right, preferentially in a direction longitudinally to the sheet,” the layout area division part 1721 generates split allocation areas BHL1 to BHL8, as shown in FIG. 9A.

When the number of records in a layout list LL is an odd number of three or more, “1 ” is added to the number of records to obtain an even number, and division is carried out by this even number. For instance, when the number of records is an odd number, “5”, the layout area division part 1721 adds “1” to “5” to obtain “6”, and division is carried out by “6”. This enables to generate split allocation areas BHL having a good style on a layout area LE. FIG. 9B shows the state that the layout area division part 1721 generates split allocation areas BHL9 to BHL13, when the number of records in a layout list LL is “5” and the “allocation direction” is “from the uppermost on the right side of the sheet to downward toward the left, preferentially in a direction laterally to the sheet.”

In step S17, the rough layout data creation part 172 allocates the expression information AJ and image data IM described by image-data storage location information stored in the records of a layout list LL to the respective split allocation areas BHL.

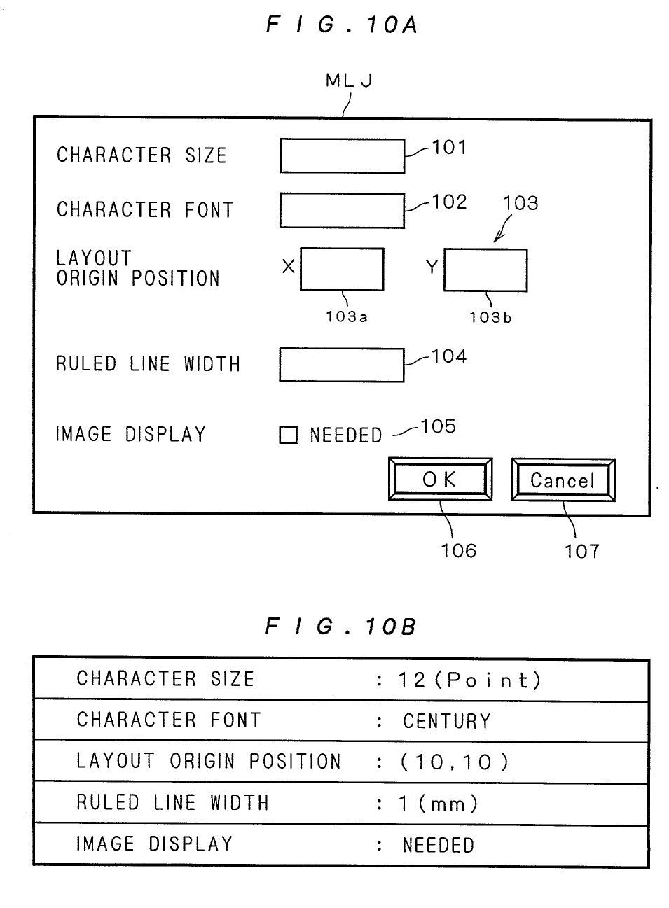

By displaying on the display part 12 a style setting menu MLJ for setting the style by which expression information AJ are allocated to split allocation areas BHL, as shown in FIGS. 10A and 10B, the rough layout data creation part 172 prompts the user to input the settings for allocating the expression information AJ to the split allocation areas BHL.

The style setting menu MLJ has a character size setting field 101, character font setting field 102, layout origin setting field 103, ruled-line width setting field 104, image display setting field 105, OK button 106, and cancel button 107.

The character size setting field 101 is used for setting the character size of expression information AJ to be allocated to split allocation areas BHL. When the user sets the desired character size in the character size setting field 101, all the expression information AJ as text are allocated to the respective split allocation areas BHL in the character size so set.

Character size can be expressed in any unit such as “point”, “Q”, or “mm”.

The character font setting field 102 is used for setting the font of expression information AJ to be allocated to the split allocation areas BHL. When the user sets the desired character font in the character, font setting field 102, all the expression information AJ as text are allocated to the respective split allocation areas BHL in the character font so set.

Any font can be used. Alternatively, any font that is unavailable in the client 1 can be specified. This will be described later.

The layout origin setting field 103 is used for setting the layout origin when allocating expression information AJ to split allocation areas BHL. In order that the user sets a layout origin coordinate HP of expression information AJ in each split allocation area BHL, the layout origin setting field 103 has an X-coordinate setting field 103a and Y-coordinate setting field 103b. The layout origin coordinates HP so set is handled as a coordinate to each split allocation area BHL, not a coordinate to a layout area LE. The user sets the desired layout origin in the X-coordinate setting field 103a and Y-coordinate setting field 103b, thereby all the expression information AJ are allocated to the respective split allocation areas BHL from the layout origin so set.

The layout origin coordinate can be expressed in any unit.

Alternatively, the layout origin can be set by specifying it on the split allocation areas BHL displayed on the display part 12, while operating the input part 13.

The ruled-line width setting field 104 is used for setting a ruled line to the border of each split allocation area BHL. The user sets the desired ruled line width in the rule-line width setting field 104, thereby the ruled-line width so set is drawn on all the borders of split allocation areas BHL.

The ruled-line width can be expressed in any unit.

The image display setting field 105 is used for setting as to whether allocated image based on image-data storage location information is displayed or not at the time of displaying on the display part 12 the rough layout result on which all the expression information AJ are allocated to the respective split allocation areas BHL. When the user clicks the check button in the image display setting field 105, all the images allocated to the respective split allocation areas BHL are displayed. The images to be displayed at this time are not yet converted to low-resolution image in the image conversion part 1723. Unless the user clicks the check button, there is no display of the images allocated to the split allocation areas BHL.

When the user clicks the OK button 106 after completing all the inputs to the style setting menu MLJ, the rough layout data creation part 172 creates an expression information style setting information ATD and terminates the style setting menu MLJ. If the user desires to cancel the style setting to the style setting menu MLJ, the user clicks the cancel button 107. As the result, the rough layout data creation part 172 terminates the style setting menu MLJ, without creating any expression information style setting information ATD.

FIG. 10B is a diagram showing the configuration of an expression information style setting information ATD created by performing setting to the style setting menu MLJ. In FIG. 10B, the expression information style setting information ATD contains the following information: “12-point” in character size; “Century” in character font; “(x, y)=(10, 10)” in layout origin coordinate; “1 mm” in ruled-line width; and “needed” in image display.

The rough layout data creation part 172 allocates the expression information AJ and the image-data storage location information stored in the layout list LL to the respective split allocation areas BHL, by referring to the created expression style setting information ATD.

Subsequently, the rough layout data creation part 172 reads the layout list LL that the user specified in step S13, and allocates the expression information AJ1 stored in the first entry of the first record of the layout list LL, to the split allocation area BHL having a minimum of numbering. When allocating the expression information AJ1, the rough layout data creation part 172 operates such that the expression information AJ1 is displayed in the character size and character font stored in the expression information style setting information ATD. The rough layout data creation part 172 also allocates the expression information AJ1 such that the set layout origin coordinate locates at the upper left hand corner of the corresponding split allocation area BHL.

At the completion of the allocation of the expression information AJ1, the rough layout data creation part 172 performs line feed processing and allocates expression information AJ2 stored in the second entry of the first record, to a lower side of the expression information AJ1. The rough layout data creation part 172 repeats allocation of the expression information AJ and/or the image-data storage location information stored in the first record until all the expression information AJ and/or the image-data storage location information stored in the first record are allocated. The creation part 172 then allocates the expression information AJ and/or the image-data storage location information of the second record to the next succeeding split allocation area BHL in an ascending order of the numbered split allocation areas BHL.

At the time that all the expression information AJ and/or the image-data storage location information are allocated to the respective split allocation areas BHL, the rough layout data creation part 172 regards that a rough layout information KLD is created and performs the following steps: (i) drawing a ruled line on the border of each split allocation area BHL in the ruled-line width set in the expression information style setting information ATD; (ii) if image display is set in the information ATD, displaying on the split allocation areas BHL the corresponding images that have been converted to low-resolution image in the image conversion part 1723; and (iii) displaying the layout area LE having a rough layout on the display part 12.

If a certain character font that the client 1 does not have is specified in the character font setting field in the expression information style setting information ATD, the rough layout data creation part 172 uses one that is most similar to the specified character font.

Allocation of the expression information AJ to the split allocation areas BHL can be performed by using techniques as disclosed by the present applicant in Japanese Patent Unexamined Publication No. 10-172000 (1998) or 11-328169 (1999).

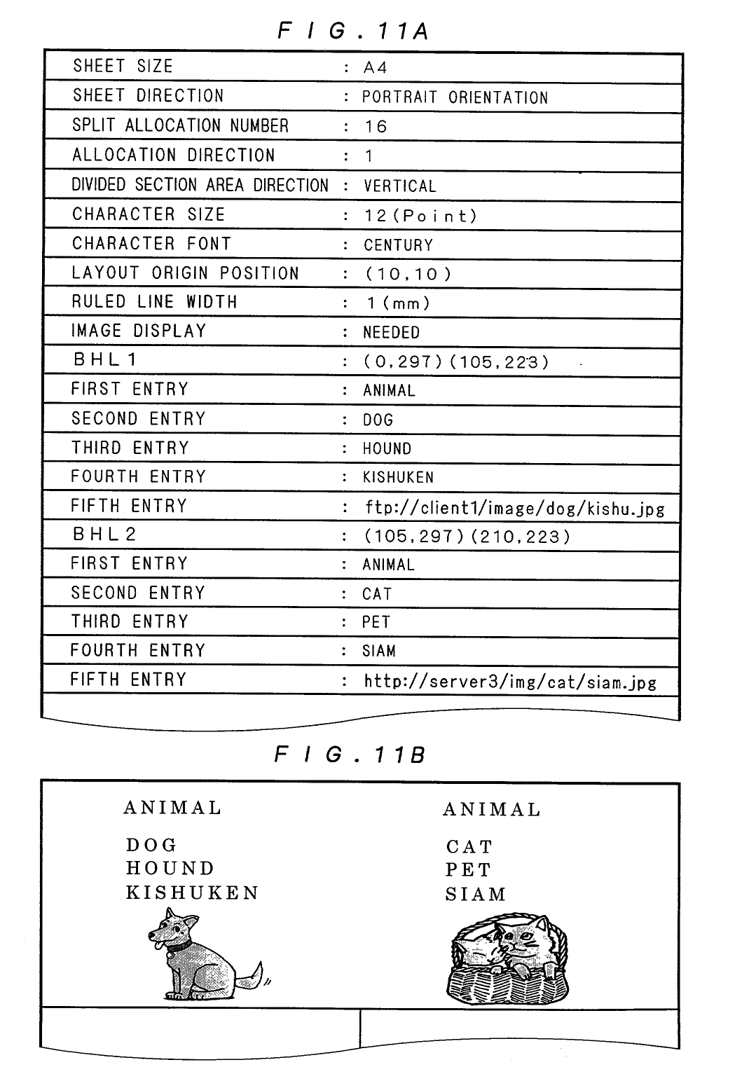

FIG. 11A shows the configuration of a rough layout data KLD1 that is obtained by performing rough layout of the layout list LL shown in FIG. 6, based on the layout setting information LSD and expression information style setting information ATD that are shown in FIGS. 7A and 7B. In the rough layout data KLD1, the expression information AJ and the image-data storage location information stored in the records of a layout list LL are respectively associated with the corresponding split allocation area BHL. FIG. 11B shows the state of display on the display part 12, according to the rough layout data KLD1 in FIG. 11A.

In step S18, the user determines whether the rough layout data KLD created in step S17 should be edited or not. If the user is satisfied with the displayed rough layout result, it goes to step S20. If the user desires edit, it goes to step S19.

In step S19, the rough layout data KLD created in step S17 is edited in the edit part 1724. That is, in order to edit the rough layout data KLD displayed on the display part 12, the user operates the input part 13 to activate the functions of area transformation part 17241, character size transformation part 17242, and character font transformation part 17243, which are provided in the edit part 1724.

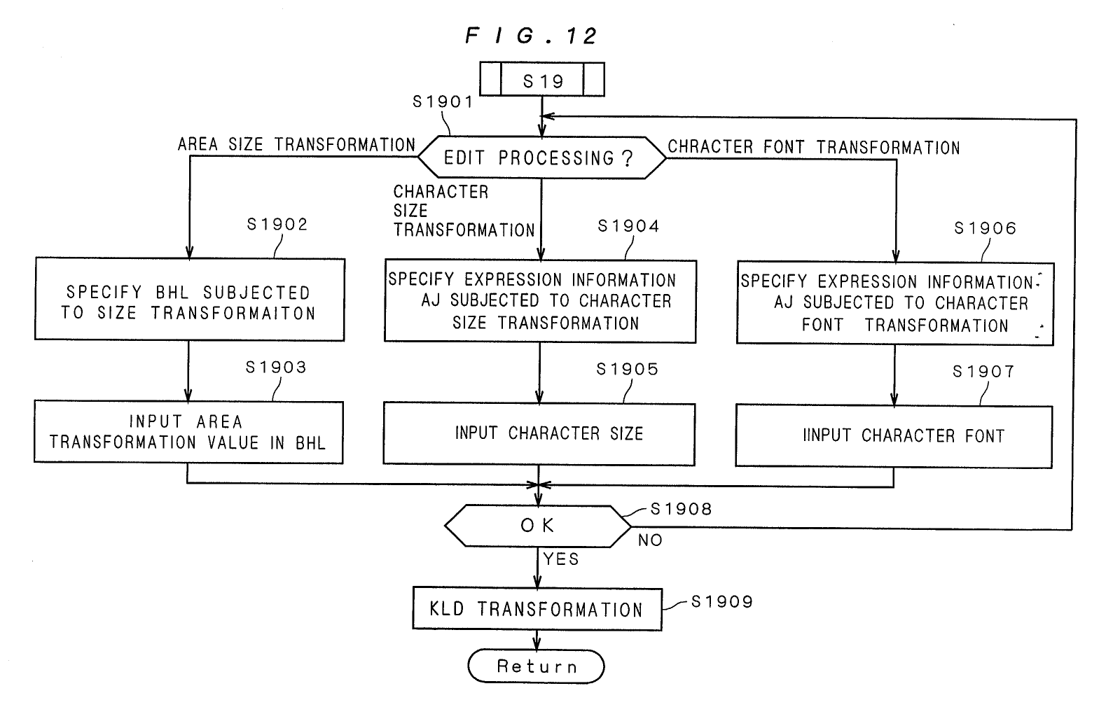

FIG. 12 is a flowchart showing the operation of edit processing in step S19. [The user activates the edit part 1724 and selects the desired edit content in step S1901. The user goes to step S1902 for area size transformation, or step S1904 for character size transformation, or step S1906 for character font transformation.

Area Size Transformation

In step S1902, the user operates the input part 13 and specifies the desired split allocation area BHL on the layout area LE displayed on the display part 12. The split allocation area BHL can be specified, for example, by a method of clicking any area edge of the displayed split allocation area BHL with the use of a mouse pointer PO that is operated by the input part 13.

After specifying the split allocation area BHL that should be subjected to area size transformation, the user performs operation for transforming its area size. The user operates the input part 13 to activate the area transformation part 17241 such that the size of the split allocation area BHL is enlarged or reduced. According to the user's operation, the area transformation part 17241 performs enlargement or reduction of the size of the split allocation area BHL. For instance, the user specifies either one side or vertex of the specified split allocation area BHL by clicking with the mouse pointer PO, and drags while holding the specified side or vertex with the mouse pointer PO. Based on the drag, the amount of movement on the coordinate is inputted to the area transformation part 17241. The inputted amount of movement is added to or reduced from the area size of the split allocation area BHL in the area transformation part 17241, thereby transforming the area size of the corresponding split allocation area BHL stored in the rough layout data KLD (step S1903). At the completion of the area size transformation, it goes to step S1908.

If the area size transformation in step S1903 is an enlargement of the area, the number of records in a layout list LL to be allocated to the layout area LE having the split allocation area BHL so enlarged is decreased according to the amount of transformation in area size. The expression information AJ stored in the decreased number of records are reallocated to the next succeeding page.

Character Size Transformation

In step S1904, the user operates the input part 13 to specify the desired expression information AJ displayed on the display part 12. Displayed expression information AJ can be specified, for example, by a method of dragging with the mouse pointer PO operated by the input part 13. The expression information AJ specified by such a method is generally subjected to inversion of display color.

In step S1905, the character size transformation part 17242 transforms the specified character size of the expression information AJ. When the user activates the character size transformation part 17242, the character size transformation part 17242 functions to display a character size transformation window on the display part 12. When the user inputs the desired character size to the displayed character size transformation window, the character size transformation part 17242 transforms the corresponding expression information AJ stored in the rough layout data KLD. At this time, a character size information of which character size is different from that set in the expression information style setting information ATD is appended to the corresponding expression information AJ.

After the user completes the character size transformation, it goes to step S1908.

Character Font Transformation

In step S1906, the user operates the input part 13 to specify the desired expression information AJ displayed on the display part 12. Displayed expression information AJ can be specified, for example, by a method of dragging with the mouse pointer PO operated by the input part 13. The expression information AJ specified by such a method is generally subjected to inversion of display color.

In step S1907, the character font transformation part 17243 transforms the specified character font of the expression information AJ and the image data IM described by image-data storage location information. When the user activates the character font transformation part 17243, the character font transformation part 17243 functions to display a character font transformation window on the display part 12. When the user inputs the desired character font to the displayed character font transformation window, the character font transformation part 17243 transforms the corresponding expression information AJ stored in the rough layout data KLD. At this time, a character font information of which character font is different from that set in the expression information style setting information ATD is appended to the corresponding expression information AJ.

After the user completes the character font transformation, it goes to step S1908.

In step S1908, the user determines whether edit processing is terminated or not. If desired to continue edit processing, it returns to step S1901 and the edit part 1724 is activated again. On the other hand, if desired to terminate edit processing, it goes to step S1909. The edit part 1724 rewrites the contents of the rough layout data KLD stored in the storage part 16, and it returns to step S20 in the flowchart of FIG. 5.

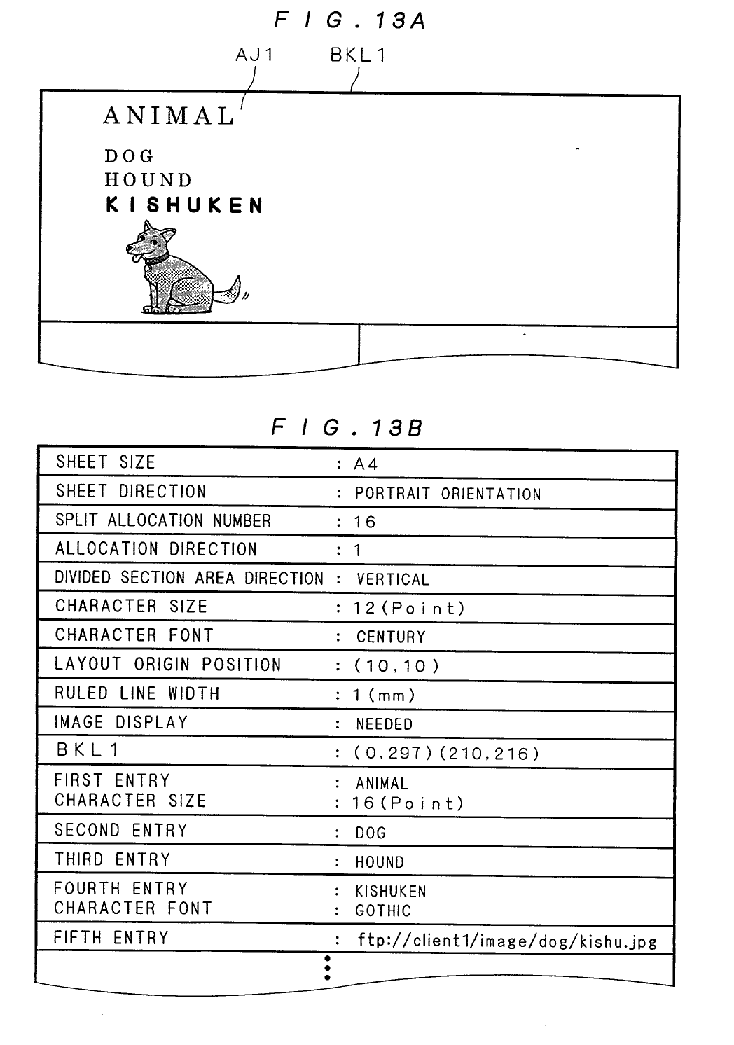

FIG. 13A shows the result displayed on the display part 12 based on a rough layout data KLD2 that has been transformed by the edit processing in step S19. FIG. 13B shows the configuration of the rough layout data KLD2. The layout display shown in FIG. 11B is transformed to that shown in FIG. 13A by performing the following edit processing. That is, the area size of the split allocation area BKL1 is enlarged; the character size of the expression information AJ1 allocated to the split allocation area BKL1 is transformed from 12-point to 16-point; and the character font of the expression information AJ1 is transformed from “Century” to “Gothic”.

In step S20, a text script output part 1722 outputs the rough layout data KLD created by the rough layout data creation part 172, as a text script to which a format information is appended. In the event that the rough layout data KLD created through steps S17 to S19 is transferred to the server 3 in a format used for input, this could waste time on transfer. Hence, to save transfer time, the text script output part 1722 converts the rough layout data KLD to a text script TS to which a format information is appended, and outputs the text script TS. Based on the text script TS, a print layout data PLD is created in the server 3.

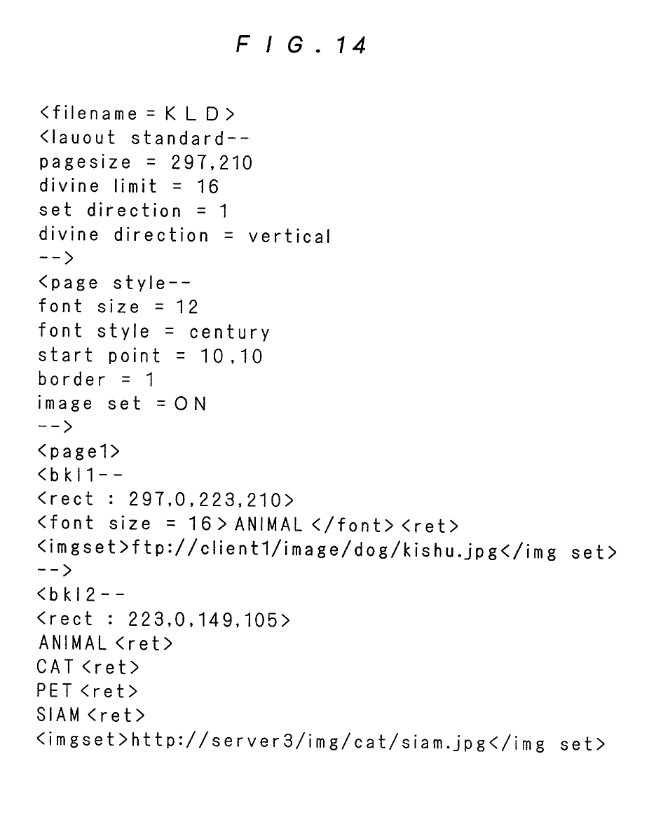

FIG. 14 shows an example that the rough layout data KLD2 is outputted as a text script TS1.

After the text script TS is outputted in step S20, it returns to the flowchart of FIG. 4. The client 1 sends the rough layout data KLD that has been converted to the text script TS, to the server 3 via the network 2. The rough layout data KLD sent from the client 1 is received at a rough layout data receiving part 371 in the server 3, and the rough layout data KLD that has been sent as the text script TS is reconverted to a file in the format initially created by the client 1 (step S2).

In step S3, a print layout data creation part 373 in the server 3 creates a print layout data.

By referring to the “sheet size” and “sheet direction” of the layout setting information LSD stored in the rough layout data KLD, the print layout creation part 373 determines a print layout area PLE for print layout data PLD, and allocates the expression information AJ to the print layout area PLE by using the information stored in the rough layout data KLD.

Firstly, the print layout data creation part 373 reads the setting about “character font” stored in the rough layout data KLD and obtains the corresponding character font from a part data storage part 372. The part data storage part 372 stores part data BD necessary for creating print layout data, such as font, image, and line drawing. Therefore, based on the setting about “character font” stored in the rough layout data KLD, the print layout data creation part 373 can obtain the corresponding character font as the part data BD, from the part data storage part 372.

Since the character fonts necessary for print layout data creation are stored in the part data storage part 372 in the server 3, there is no problem even when a certain character font unavailable in the client 1 is used for rough layout data creation in the client 1.

The print layout data creation part 373 reads the area size of each split allocation area BHL and the ruled-line width of its area border from the rough layout data KLD, and creates expression information allocation frames ADH that correspond to the area sizes of the split allocation areas BHL, respectively. Then, the print layout data creation part 373 allocates the expression information AJ and/or the image data IM described by image-data storage location informationstored in the rough layout data KLD to the expression information allocation frames ADH, respectively.

When the expression information AJ is a text, the print layout data creation part 373 allocates the expression information AJ in the set character size by using the character font obtained from the part data storage part 372.

When rough layout data KLD contains an image data storage location information, the print layout data creation part 373 obtains image data IM from the image data storage location information and allocates the image data to the expression information allocation frames ADH. At this time, the print layout data creation part 373 fetches an image data IM by referring to the image data storage location information. Therefore, the image data that the client 1 desires can be used for print layout data PLD by fetching the image data IM stored in a location other than the part data storage part 372 in the server 3. The image data IM fetched by the print layout data creation part 373 is stored in the part data storage part 372, as a part data BD.

The image data IM fetched by the print layout data creation part 373 has a relatively high resolution. That is, the print layout data creation part 373 fetches the image data IM without performing any resolution conversion such as pixel skipping. As the result, the printed matter of the printed layout data PLD is of high-quality image expression.

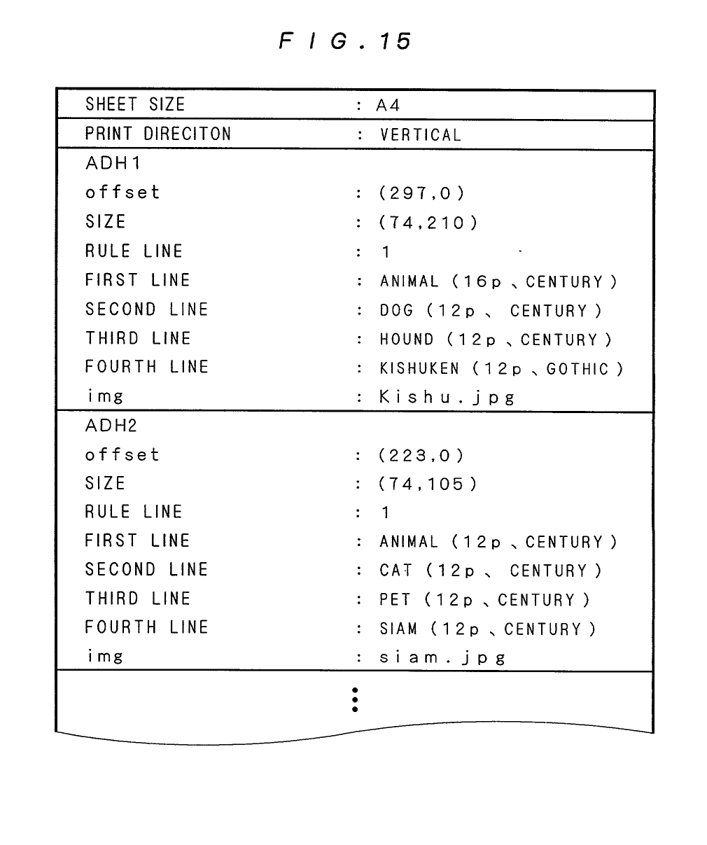

FIG. 15 shows the configuration of a print layout data PLD1 that the print layout data creation part 373 creates by referring to a rough layout data KLD2. Unlike the rough layout data KLD, the settings of “split allocation number,” “allocation direction,” and “divided section area direction” are eliminated from a print layout data PLD. That is, in the print layout data PLD, these settings are handled as one to which no transformation is performed. Further, the setting of “image display” is eliminated so that image is always displayed at the time of layout display based on the print layout data PLD.

In step S3, when the print layout data creation part 373 terminates the creation of the print layout data PLD by referring to the rough layout data KLD, the print layout data PLD is stored in the storage part 36 and it is not transferred to the print processing part 374 until the client 1 issues a print instruction.

In step S4, a proof image creation part 3731 creates a proof image KD based on the print layout data PLD. That is, from the print layout data PLD, the proof image creation part 3731 creates such a proof image KD that can display the expression of a printed matter as it is, although its data amount and resolution are low. The created proof image KD is sent to the client 1.

In step S5, the user of client 1 displays on the display part 12 the proof image KD sent from the server 3, and judges whether the desired printed matter is obtainable from the print layout data PLD by visually confirming the proof image KD. If the user is unsatisfied with the proof image KD, it returns to step S1 and executes recreation of a rough layout data KLD.

If the user is satisfied with the proof image KD, it goes to step S6. The user operates the input part 13 in client 1 and issues a print instruction to the server 3. That is, the user activates a print instruction issue part 173 to issue a print instruction that contains the user name, the number of copies of the printed matter, and printed matter destination, to the print processing part 374 in the server 3.

Alternatively, if the print processing pat 374 has the same function as the print instruction issue part 173, the user of client 1 may input to the print processing part 374 so as to execute the same processing as described above.

In step S6, the server 3 reads the print layout data PLD stored in the storage part 16 and transfers it to the print processing part 374, thereby starting print processing. Specifically, the print processing part 374 reads and rasterizes the print layout data PLD, thereby obtaining a rasterized print data RPD of binary bitmap format acceptable to the printer 4. The print processing part 374 transfers the rasterized print data RPD to the printer 4 via the communication line CL, thereby performing printing in the printer 4.

In this connection, the print processing part 374 determines the number of copies of the printed matter etc., according to the script contained in the print instruction issued from the client 1. The print processing part 374 performs processing such that the scripts of the user name and printed matter destination are printed in an assorting sheet for discriminating the resulting printed matter of the rasterized print data RPD.

The printing system 100 of FIG. 1 can easily provide a printed matter having the desired layout by performing the operations shown in the flowcharts of FIGS. 4 and 5, without requiring the user to make detail setting for obtaining the printed matter.

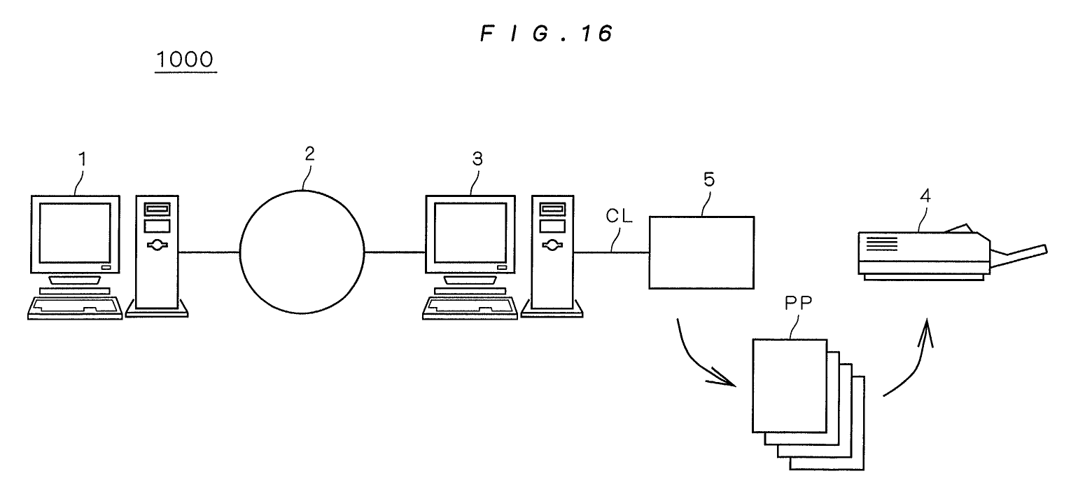

The foregoing description is directed to the printing system using the printer 4 that can directly output the rasterized print data RPD that is obtained by rasterizing the print layout data PLD outputted from the server 3. It is also applicable to a printing system in which a printing plate PP is made based on a rasterized print data RPD and the printer 4 performs printing by using the printing plate PP. FIG. 16 is a diagram showing the configuration of a printing system 1000 featuring a CTP (Computer To Plate maker) that makes a printing plate PP based on the rasterized print data RPD. Referring to FIG. 16, server 3 is connected to CTP 5 via communication line CL. The CTP 5 makes a printing plate PP from the rasterized print data RPD sent from the server 3. By fitting the printing plate PP in the printer 4, a rough layout data KLD created by the client 1 can be printed. That is, a printed matter having the desired layout can be obtained easily without requiring the user to make detail settings for obtaining the printed matter.

Second Preferred Embodiment

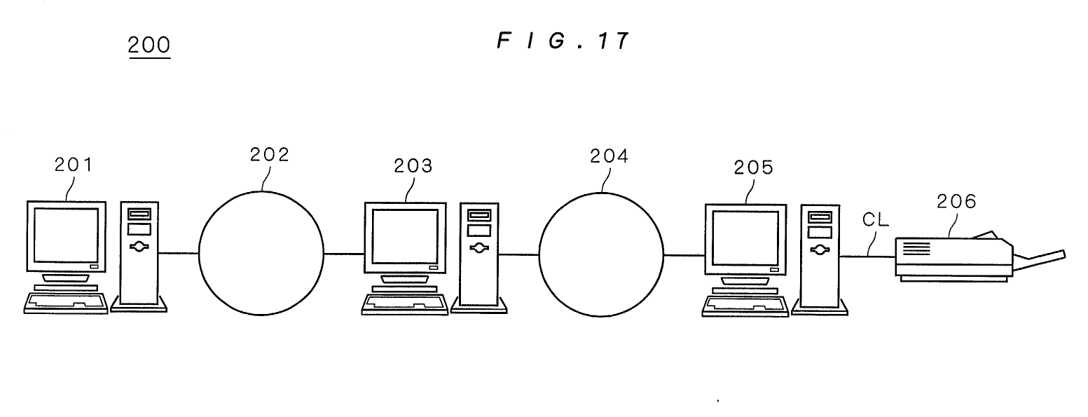

FIG. 17 is a diagram showing the configuration of a printing system 200. The printing system 200 comprises client 201, networks 202 and 204, layout server 203, print server 205, and printer 206. Since the client 201, networks 202, 204 are the same as in FIG. 1, its description is omitted here.

The layout server 203 is placed under control of a printing coordinator and it creates a print layout data in which a part data necessary for printing is allocated by referring to a rough layout data sent from client 201.

The print server 205 is placed under control of a printing dealer that makes a printed matter, and it receives the print layout data PLD sent from the layout server 203 and performs printing in the printer 206 connected via communication line CL.

In this instance, although only one client 201 is connected to the network 202, plural clients 201 may be connected to the network 202. Further, although only one print server 205 is connected to the layout server 203, plural print servers 205 may be connected to the layout server 203.

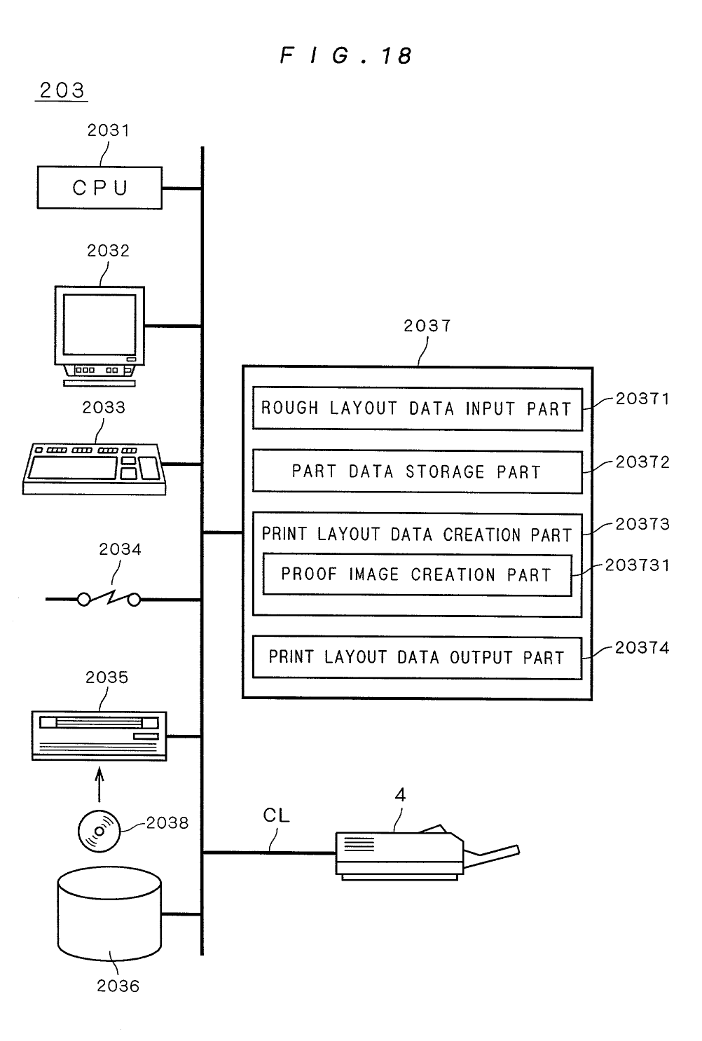

FIG. 18 is a diagram showing the configuration of the layout server 203. Since this configuration is the same as that shown in FIG. 3, except for network interface 2034 and memory 2037, its description is omitted here.

The network interface 2034 connects the layout server 203 to the networks 202 and 204. The layout server 203 receives via the network interface 2034 a rough layout data KLD from the client 201 connected to the network 202. The layout server 203 sends the client 201 an image data IM and proof image KD stored in the layout server 203, and also sends a print layout data PLD to the print server 205 via the network 204.

The memory 2037 is a work area where CPU 2031 executes a program stored in storage part 2036. The program executed by the CPU 2031 implements, in the memory 2037, the functions of rough layout data creation part 20371, part data storage part 20372, print layout data creation part 20373, and print layout data output part 20374. Since the configuration except for print layout data output part 20374 is the same as that shown in FIG. 3, its description is omitted here.

The print layout data output part 20374 outputs a print layout data PLD to the print server 205 via the network 204. The print layout data output part 20374 accepts a print instruction issued by client 201 and sends the print layout data PLD stored in the storage part 2036 to the print server 205.

The print processing part 20374 may further have the same function as the print instruction issue part (not shown) provided in the client 201. In this instance, the same effect as mentioned above can be obtained by such a configuration that the user of client 201 accesses to the print processing part 20374 via the network 202 and issues a print instruction.

The above-mentioned control prevents unnecessary operation in the print processing part 20374, thus avoiding a waste of the resources in the print server 205.

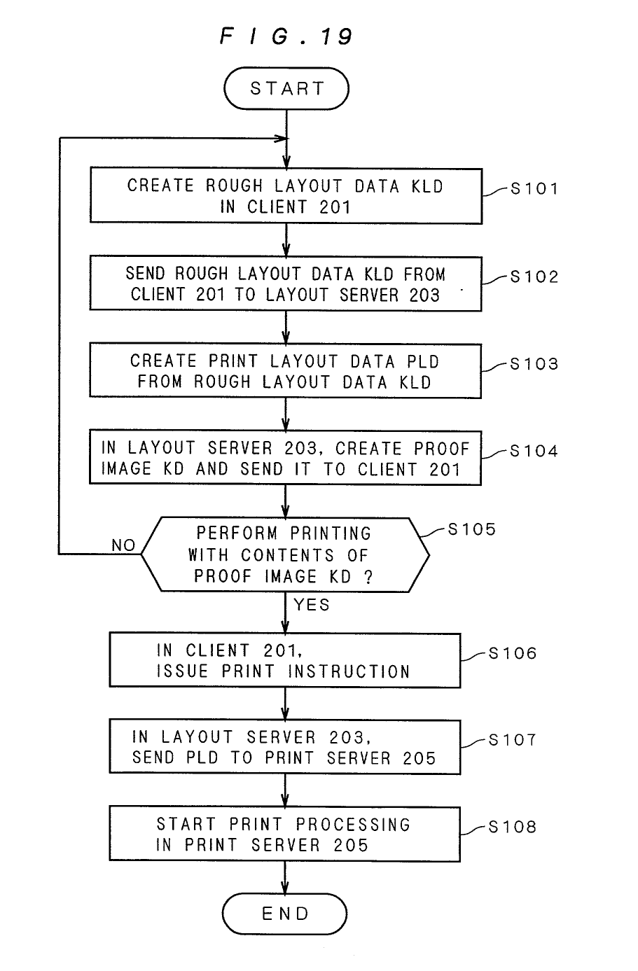

FIG. 19 is a flowchart showing the operation of a printing system 200. Since the operations from steps S101 to S105 are the same as that in FIG. 4, its description is omitted here.

In step S106, the user of client 201 checks a proof image KD and issues a print instruction. That is, the user operates the input part 20313 to activate a print instruction issue part (not shown) provided in the client 201, and issues a print instruction that contains scripts such as the user name, the number of copies of the printed matter, and the printed matter destination, to the layout server 203.

Alternatively, if the print layout data output part 20374 has the same function as the print instruction issue part (not shown) in the client 201, the user of client 201 may input to the print layout data output part 20374 so as to execute the same processing as described above.

In step S107, the print layout data output part 20374 sends a print layout data PLD to the print server 205 according to the print instruction issued by the user of client 201. The print server 205 receives and rasterizes the print layout data PLD, thereby creating a rasterized print data RPD of binary bitmap format acceptable to the printer 206. The print server 205 then transfers the created rasterized print data RPD to the printer 206 via the communication line CL, thereby performing printing in the printer 206.

At this time, according to the scripts contained in the print instruction issued from the client 201, the print layout data output part 20374 determines the number of copies of the printed matter etc. Based on the determination, the print server 205 performs control of print processing. The print layout data output part 20374 determines that the scripts of the user name and printed matter destination are printed in an assorting sheet for discriminating the resulting printed matter of the rasterized print data RPD. Based on the determination, the print server 205 controls print processing.

The printing system 200 of FIG. 17 can easily provide a printed matter having the desired layout by performing the operations shown in the flowchart of FIG. 19, without requiring the user to make detail settings for obtaining the printed matter.

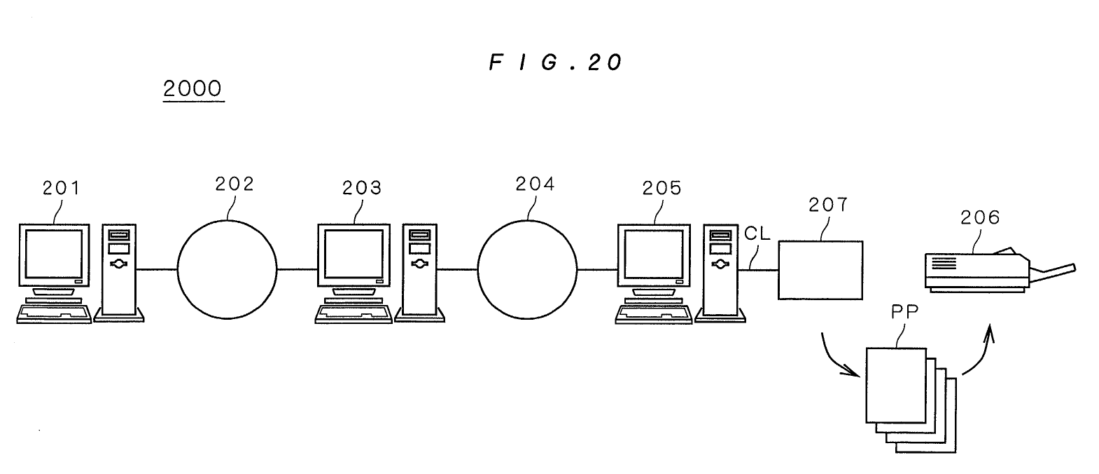

The foregoing description is directed to the printing system in which the printer 206 connected to the print server 205 performs printing of the rasterized print data RPD that is obtained by rasterizing the print layout data PLD outputted from the layout server 203. It is also applicable to a printing system in which a printing plate PP is made based on a rasterized print data RPD and the printer 206 performs printing by using the printing plate PP. FIG. 20 is a diagram showing the configuration of a printing system 2000 using a CTP (Computer To Plate maker) that makes a printing plate PP based on a rasterized print data RPD. Referring to FIG. 20, print server 205 is connected to CTP 207 via communication line CL. The CTP 207 makes a printing plate PP based on the rasterized print data RPD sent from the print server 205. By fitting the printing plate PP in the printer 206, the rough layout data KLD created by the client 201 can be printed. That is, a printed matter having the desired layout can be obtained easily without requiring the user to make detail settings for obtaining the printed matter.

Modifications

Although in the foregoing description, the print execution part 374 is provided in the inside of the server 3, the print execution part 374 may be provided in the exterior (e.g., the printer 4), which is connected so as to make communication with the server 3. This is true for other components of the server 3.

Although in the foregoing description, the rough layout data KLD is sent on online from the client 1 to the server 3 (or from the client 201 to the layout server 203), it may be transferred from the client 1 to the server 3 (or from the client 201 to the layout server 203) by the media disk 18 (or 20318) that stores the rough layout data KLD.

Also in this instance, the same effect as described above can be obtained with the construction that the client 1 (or 201) issues on online a print instruction to the server 3 (or the layout server 203).

Although in the foregoing description, the proof image KD is sent on online from the server 3 to the client 1 (or from the layout server 203 to the client 201), it may be transferred from the server 3 to the client 1 (or from the layout server 203 to the client 201) by the media disk 18 (or 20318) that stores the proof image KD. Alternatively, it may be configured that the proof image KD is printed by a printer (not shown) provided in the server 3 (or the layout server 203), and the printed matter of the proof image IM is sent to the user of client 1 (or 201).

Also in this instance, the same effect as described above can be obtained with the construction that the client 1 (or 201) issues on online a print instruction to the server 3 (or the layout server 203).

In addition, although in the foregoing description, the print layout data PLD is sent on online from the layout server 203 to the print server 205, it may be transferred from the layout server 203 to the print server 205 by the media disk 20318 that stores the print layout data PLD.

Also in this instance, the same effect as described above can be obtained with the construction that the client 201 issues n online a print instruction to the layout server 203.

Alternatively, the client 201 may have the same function as the print server 205.

Also in this instance, the same effect as described above can be obtained with the construction that the client 201 issues on online a print instruction to the layout server 203.

While the invention has been shown and described in detail, the foregoing description is in all aspects illustrative and not restrictive. It is therefore understood that numerous modifications and variations can be devised without departing from the scope of the invention.

What is claimed is:

1. A printing system comprising:
(a) a client computer comprising:
a layout list creation element for creating at least one layout list information,
said layout list information containing at least one expression information that is information expressed on a printed matter;
a rough layout data creation element for creating a rough layout data based on said layout list information; and
a sending element for sending said rough layout data to a network, and
(b) a first server computer comprising:
a receiving element for receiving said rough layout data from said network;
a part data storage element for storing part data used in expressing a printed matter;
a print layout data creation element for creating a print layout data based on said rough layout data; and
a print control element for directing a printer to print said print layout data,
said first server computer connected to the printer that receives a print layout data from the exterior of said printer and performs printing.

2. The printing system according to claim 1, wherein
said rough layout data creation element virtually divides a layout area in said printed matter into a plurality of sub-layout areas based on the number of said expression information, and performs layout of said expression information on said sub-layout areas one by one.

3. The printing system according to claim 1, wherein
said rough layout data creation element virtually divides a layout area in said printed matter into a plurality of sub-layout areas based on the number of said layout list information, and perform layout of said layout information on said sub-layout areas one by one.

4. The printing system according to claim 1, wherein
said rough layout data creation element creates said rough layout data as a text script, said text script containing a format information indicated by a tag.

5. The printing system according to claim 1, wherein
said layout list information further contains an image data storage location information indicating image data storage location, and
said rough layout data creation element fetches said image data based on said image data storage location information to make possible to display a layout expression containing said image data.

6. The printing system according to claim 1, wherein
said client computer further comprises an edit element capable of editing said rough layout data.

7. The printing system according to claim 1, wherein
said rough layout data creation element creates said rough layout data as a text script, said text script containing a format information indicated by a tag, and
said print layout data creation element creates a print layout data by reading a part data from said part data storage element by referring to said text script.

8. The printing system according to claim 5, wherein
said print layout data creation element creates a print layout data containing said image data, based on said rough layout data containing said image data storage location information.

9. The printing system according to claim 1, wherein
said printer performs printing based on said print layout data in accordance with an instruction from said client computer.

10. The printing system according to claim 1 further comprising:
a second server computer comprising:
a receiving element for receiving said print layout data from said network; and
a print control element for directing said printer to print said print layout data, wherein
said first server computer further comprises a sending element for sending said print layout data to said network.

11. A client computer of printing system comprising:
a) a layout list creation element for creating at least one layout list information,
said layout list information containing at least one expression information that is desired to be expressed in a printed matter;
b) a rough layout data creation element for creating rough layout data based on said layout list information; and
c) a sending element for sending said rough layout data to a server computer.

12. A server computer of printing system comprising:
(a) a receiving element for receiving a rough layout data sent from a client computer via a network;
(b) a part data storage element for storing a part data used in expressing a printed matter;
(c) a print layout data creation element for creating a print layout data based on said rough layout data; and
(d) a print control element for directing a printer to print said print layout data.

13. A program to be executed on a client computer of printing system thereby to implement on said client computer the following elements:
(a) a layout list creation element for creating at least one layout list information;
said layout list information containing at least one expression information that is desired to be expressed in a printed matter;
(b) a rough layout data creation element for creating a rough layout data based on said layout list information; and
(c) a sending element for sending said rough layout data to a server computer.

14. A program to be executed on a server computer of printing system thereby to implement on said server computer the following elements:
(a) a receiving element for receiving a rough layout data sent from a client computer;
(b) a part data storage element for storing a part data used in expressing a printed matter;
(c) a print layout data creation element for creating a print layout data based on said rough layout data; and
(d) a print control element for directing a printer to print said print layout data.
